(19) United States
(12) Patent Application Publication
(10) Pub. No.: US 2006/0283071 A1
(43) Pub. Date: Dec. 21, 2006

(54) Stabilizing keel for attachment to a waterfowl decoy

(76) Inventor: Patrick Haley, Denver, CO (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/157,662

(22) Filed: Jun. 21, 2005

(51) Int. Cl. A01M 31/06

(52) U.S. Cl. 43/3

(57) ABSTRACT

A stabilizing keel for attachment to a waterfowl decoy including a stabilizing plate having a horizontal planar surface and a first strut connected to the stabilizing plate. In addition, apparatus such as a nut/bolt combination, screws, pins, or rivets is operatively associated with the first strut for attaching the first strut to a waterfowl decoy such that the horizontal planar surface of the stabilizing plate is positioned substantially horizontally when the stabilizing keel is attached to a decoy and oriented for use. The stabilizing plate may include a vertical planar surface which is positioned normal to the horizontal planar surface. Similarly, in certain embodiments the first strut may include a first planar strut surface. The first planar strut surface and the vertical planar surface may be parallel when the stabilizing keel is operatively oriented, together forming a vertical face which is perpendicular to the horizontal planar surface of the stabilizing plate. The connection between the first strut and the stabilizing plate may be articulated. An articulated connection provides for the selective extension of the stabilizing plate away from the apparatus used to attach the stabilizing keel to a decoy and the selective collapsing of the stabilizing plate toward the attachment.

### TECHNICAL FIELD

The present invention is directed toward a stabilizing keel for attachment to a waterfowl decoy, and more particularly toward an adjustable keel including a horizontally disposed stabilizing plate.

### BACKGROUND ART

Waterfowl decoys are used by hunters or photographers to attract waterfowl to desired areas. Typically, the user of waterfowl decoys will arrange a grouping of decoys on the surface of a pond or other body of water, or arrange decoys in the meadows, fields, or swampy areas adjacent to a body of water. The hunter or photographer setting the decoys strongly desires to mimic the appearance of waterfowl feeding or resting. Live waterfowl are hopefully attracted to the pond or field upon which the decoys are set through association of the presence of the decoys with a safe and suitable habitat. Waterfowl have keen eyesight. Therefore, it is critical that the deployed decoys accurately mimic live waterfowl. Otherwise, the effectiveness of the decoys will be compromised.

Decoys which are deployed upon the surface of a pond or other body of water typically have a wooden or plastic body which is constructed to float upon the surface of the water. Underneath the body, a weighted keel is typically formed or mounted which more or less assures that the decoy floats in an upright position.

The action of wind or waves will impart torque to the body of a typical decoy. These actions can cause the decoy to rock or sway from side to side or tip to tail, particularly if the decoy is of the basic variety with a relatively small weighted keel. Live waterfowl use their webbed feet to stabilize themselves on the surface of a pond. Thus, live waterfowl typically do not rock, tip, or sway as do weighted decoys under similar wind and wave conditions. The relatively excessive rocking, tipping, and swaying of a typical weighted decoy detracts from a natural appearance, and can cause live waterfowl to shy away from the pond or other body of water upon which the decoys are set.

Although decoys are generally deployed on the surface of a body of water, in certain instances it is advisable for a hunter or photographer to set waterfowl decoys on land, typically in the fields, meadows, or marshes adjacent to a body of water. These land based decoys can be used to mimic birds at rest or grazing. Waterfowl decoys which feature a weighted keel are difficult to use in this fashion. A standard weighted keel is a relatively narrow structure, causing the decoy to tip to one side or the other when it is set upon the ground, which results in an extremely unnatural presentation. The decoy may be propped up with rocks, sticks, or other small objects, or the keel might be buried. However, this requires a great deal of time and effort on the part of the hunter or photographer. In addition, the height at which a weighted decoy sets above ground level can not be easily or precisely adjusted using rocks, sticks, or other readily available items. Thus, it is difficult to compensate for varying grass or other groundcover lengths, and it is difficult to mimic a bird at rest with its legs tucked under its body when deploying prior art decoys on land.

One advantage presented by a prior art weighted decoy is a relatively compact structure. Prior art weighted keels are relatively narrow apparatus situated close to or against the base of the decoy. On the contrary, more elaborate keel and/or weight structures which have been designed to partially address some of the shortcomings of a simple, weighted keel tend to be large, bulky structures. A single hunter or photographer may desire to transport several decoys into the field, and will be required to store several decoys between uses. Large or bulky structures attached to a decoy body can significantly limit the number of decoys which a hunter or photographer can effectively transport, carry into the field, or store.

The present invention is directed toward overcoming one or more of the problems discussed above.

### SUMMARY OF THE INVENTION

One aspect of the present invention is a stabilizing keel for attachment to a waterfowl decoy including a stabilizing plate having a horizontal planar surface and a first strut connected to the stabilizing plate. In addition, apparatus such as a nut/bolt combination, screws, pins, or rivets is operatively associated with the first strut for attaching the first strut to a waterfowl decoy such that the horizontal planar surface of the stabilizing plate is positioned substantially horizontally when the stabilizing keel is attached to a decoy and oriented for use.

The stabilizing plate may include a vertical planar surface which is positioned normal to the horizontal planar surface. Similarly, in certain embodiments the first strut may include a first planar strut surface. The first planar strut surface and the vertical planar surface may be parallel when the stabilizing keel is operatively oriented, together forming a vertical face which is perpendicular to the horizontal planar surface of the stabilizing plate.

The connection between the first strut and the stabilizing plate may be articulated. “Articulated” as used throughout this specification means connected or attached with a movable joint. An articulated connection provides for both the selective extension of the stabilizing plate away from the apparatus used to attach the stabilizing keel to a decoy and the selective collapsing of the stabilizing plate toward the attachment.

The stabilizing keel may also include a second strut similar to the first strut connected to the stabilizing plate. The second strut may include apparatus such as the nut and bolt combination described above for attachment of the second strut to the decoy body. The second strut may include a planar surface which preferably is coplanar with the planar surface of the first strut and positioned substantially vertically when the stabilizing keel is attached to a decoy and operatively deployed. The connection between the first and second struts may be articulated as described above providing for the selective extension of the stabilizing plate away from the first and second attachment structures and the selective collapsing of the stabilizing plate towards the first and second attachment structures. Preferably, the positions of the first and second articulated connections are selected to cause the horizontal orientation of the horizontal planar surface to be maintained in both the collapsed and extended positions.

Another aspect of the present invention is a waterfowl decoy including a decoy body and a stabilizing keel as described above. The stabilizing keel may be attached to the decoy body such that the vertical planar surface is held parallel to a longitudinal centerline of the decoy body. Preferred embodiments of the waterfowl decoy will include a stabilizing keel featuring articulated connections between the stabilizing plate and the first or second struts connecting the stabilizing plate to the decoy body, thus allowing the selective extension of the stabilizing plate away from the decoy body and the selective collapsing of the stabilizing plate toward the decoy body. Ideally, the positions of the first and second articulated connections will cause the horizontal orientation of the horizontal planar surface to be maintained in the collapsed and extended positions.

Another aspect of the present invention is a method of deploying a waterfowl decoy on a body of water. The method includes providing a decoy including a decoy body and a stabilizing keel as described above. In particular, the stabilizing keel includes a horizontal stabilizing plate and a vertical strut attached to both the underside of the decoy body and the horizontal plate. The method further includes manipulating the vertical strut to increase the distance between the horizontal stabilizing plate and the decoy body and placing the decoy on the surface of the body of water.

### BRIEF DESCRIPTION OF THE DRAWINGS

FIG. 1 is a perspective view of an embodiment of the present invention;

FIG. 2 is a side plan view of an embodiment of the present invention showing the stabilizing plate in an extended position;

FIG. 3 is an exploded perspective view of an embodiment of the present invention;

FIG. 4 is a front perspective view of an embodiment of the present invention;

FIG. 5 is a side plan view of an embodiment of the present invention showing the stabilizing plate in a collapsed position; and

FIG. 6 is a top plan view of an embodiment of the present invention.

### DETAILED DESCRIPTION OF THE PREFERRED EMBODIMENT

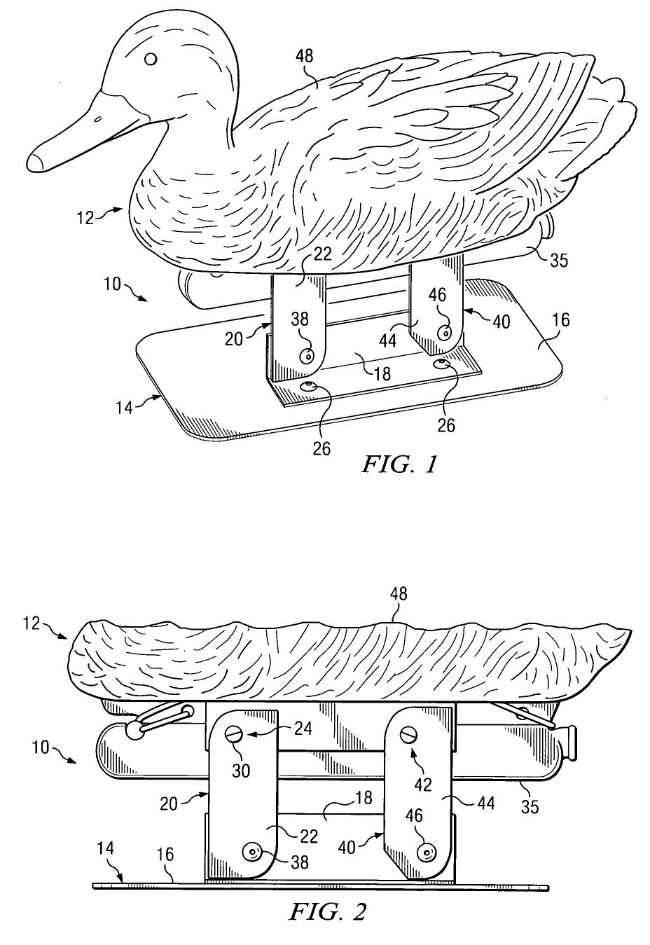

One embodiment of a stabilizing keel 10 is shown attached to a waterfowl decoy 12 in FIG. 1. The waterfowl decoy 12 shown in the accompanying figures is a duck decoy such as is commonly used to attract ducks for hunting or photography purposes. Although shown as a duck decoy in the accompanying figures, the waterfowl decoy 12 of certain embodiments of the present invention is not limited to duck decoys; the present invention is equally suitable for goose, swan, or other waterfowl decoys.

The stabilizing keel 10 includes a stabilizing plate 14 having a horizontal planar surface 16. The stabilizing plate 14 may also include a vertical planar surface 18 formed such that the vertical planar surface 18 and the horizontal planar surface 16 of the stabilizing plate 14 intersect at a substantially right angle.

In the embodiment shown in FIG. 1, the horizontal planar surface 16 of the stabilizing plate 14 is fabricated from a suitably sized piece of sheet metal. Similarly, the vertical planar surface 18 is one leg of readily available angle iron metal stock bonded with rivets 26 to the horizontal planar surface 16. The present invention includes embodiments where other fabrication methods are employed. For example, the horizontal planar surface 16 and vertical planar surface 18 of the stabilizing plate 14 could be formed from a single section of sheet metal. Alternatively, the structures could be cast, molded, or machined from suitable plastic, metal, or other stock. any suitable bonding method such as bolts, glue, welds, or crimps may be used between parts such as the horizontal planar surface 16 and the vertical planar surface 18. An alternative embodiment of the present invention does not include a vertical planar surface 18 associated with the stabilizing plate 14.

The stabilizing keel 10 also includes a first strut 20 connected to the stabilizing plate 14. The first strut 20 may include a first planar strut surface 22 which, as is shown in FIG. 1, may define a plane which is planar parallel to the vertical planar surface 18.

The connection between the first strut 20 and the stabilizing plate 14 may be a rivet 26 as is shown in FIG. 1. Alternatively, a screw, nut and bolt, pin, or other mechanical connection may be employed to join the first strut 20 to the stabilizing plate 14. Similarly, the first strut 20 may be permanently bonded to the stabilizing plate 14 with a welded, glued, or other similar permanent joint. In the embodiment of FIG. 1, the connection between the first strut 20 and the stabilizing plate 14 occurs on the vertical planar surface 18 of the stabilizing plate 14. In an alternative embodiment, the connection could be made on the horizontal planar surface 16, or another portion of the stabilizing plate 14.

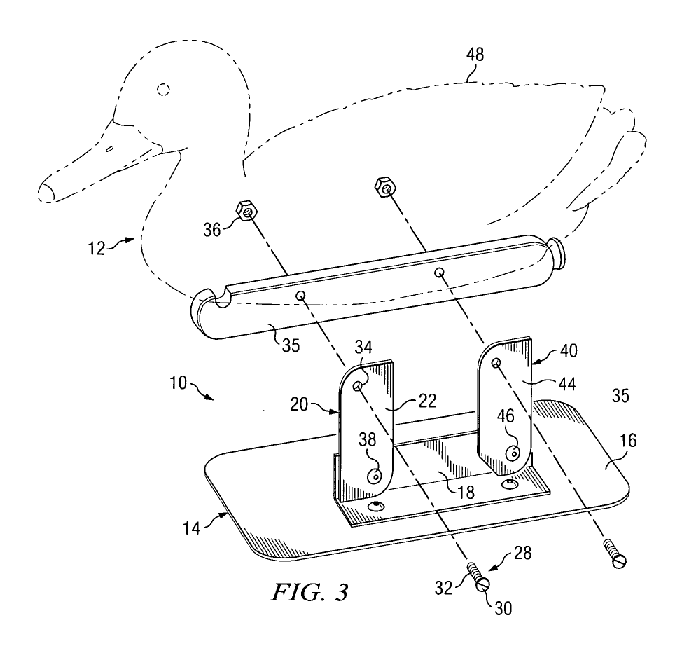

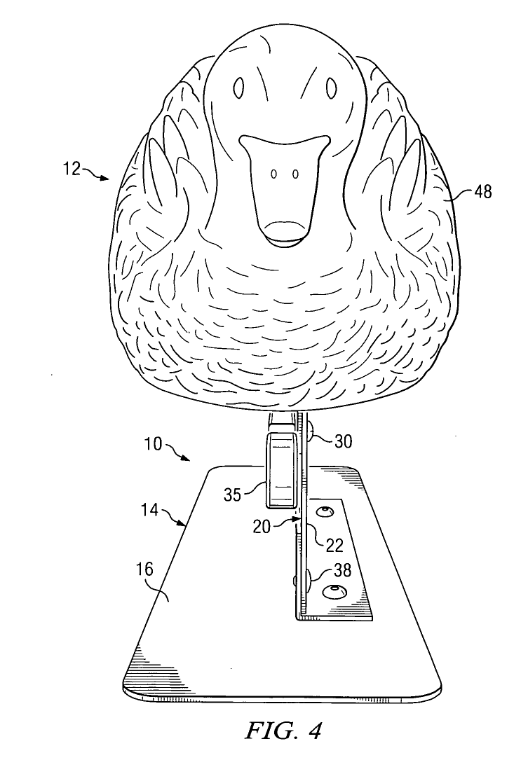

As is best shown in FIG. 2, the stabilizing keel 10 also has a first attachment means 24 operatively associated with the first strut 20 and generally located opposite the connection between the first strut 20 and the stabilizing plate 14. The first attachment means 24 facilitates the connection of the stabilizing keel 10 to a waterfowl decoy. The first attachment means 24 may be a screw, nail, nut and bolt, rivet, pin, cable, or other mechanical attachment mechanism. Alternatively, the first attachment means 24 may be a glued, welded, or other bonded joint. In the embodiment of FIG. 2, and as is better shown in the exploded view of FIG. 3, the first attachment means 24 includes a threaded machine screw 28 having a head 30 and threaded shaft 32 which is placed through a suitable hole 34 formed in the first strut 20 which is further placed through a suitable structure such as the existing keel/weight 35 of a waterfowl decoy 12 and held in place by a nut 36. As is shown in FIG. 1 and the front perspective view of FIG. 4, the first attachment means 24 provides for the attachment of the first strut 20 to the waterfowl decoy 12 such that the horizontal planar surface 16 of the stabilizing plate 14 is positioned substantially horizontally when the stabilizing keel 10 is operatively oriented.

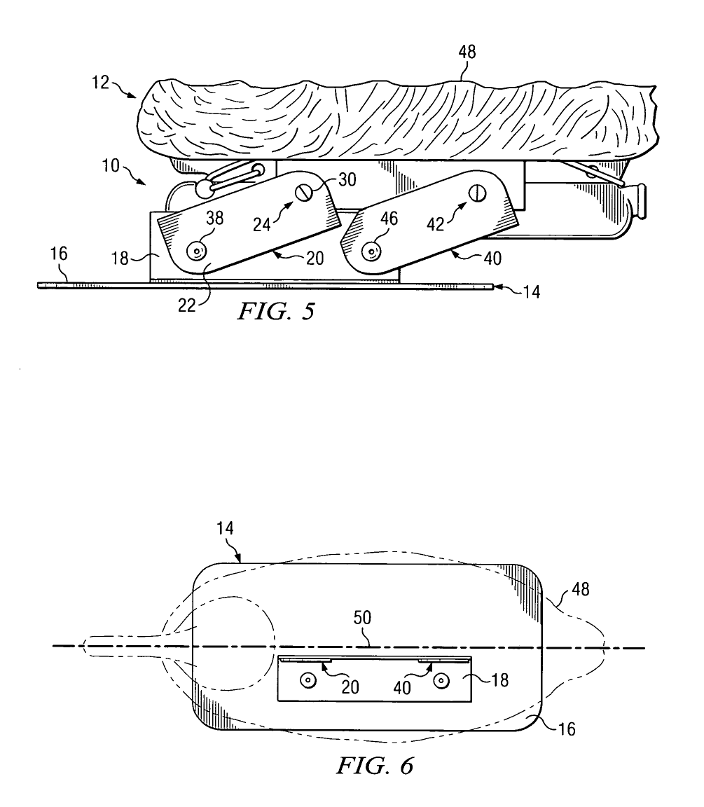

Preferably, the first strut 20 and the stabilizing plate 14 are attached to each other by a first articulated connection 38. “Articulated” as used herein is defined as connected or attached with a movable joint. A simple connection such as a rivet or a similar screw or nut/bolt combination is suitably articulated for pivoted movement. Such a connection allows the first strut 20 to pivot with respect to the vertical planar surface 18 of the stabilizing plate 14. This articulation thus provides for the selective extension of the stabilizing plate 14 away from the first attachment means 24 as shown in FIGS. 1 and 2 and, alternatively, the first articulated connection 38 provides for the selective collapsing of the stabilizing plate 14 toward the first attachment means 24 as shown in FIG. 5.

The stabilizing keel 10 may also include a second strut 40 connected to the stabilizing plate 14 in a manner similar to the connection of the first strut 20. In addition, a second attachment means 42 similar to the first attachment means 24 may be operatively associated with the second strut 40, providing for the attachment of the second strut 40 to a waterfowl decoy 12. The second strut 40 may also include a second planar strut surface 44. Certain advantages, which will become readily apparent when described below, are achieved if the first and second planar strut surfaces 22, 44 are coplanar with each other and positioned substantially vertically when the stabilizing keel 10 is operatively oriented.

The connection between the second strut 40 and the stabilizing plate 14 may be a second articulated connection 46. The second articulated connection 46 in conjunction with the first articulated connection 38 may provide for the selective extension of the stabilizing plate 14 away from the first and second attachment means 24, 42 as shown in FIGS. 1 and 2, or the selective collapsing of the stabilizing plate 14 toward the first and second attachment means 24, 42 as shown in FIG. 5.

The positions of the first and second articulated connections 38, 46 and the first and second attachment means 24, 42 may be selected such that these elements define the corners of a parallelogram as shown in FIGS. 2 and 5. Such a configuration causes the horizontal orientation of the horizontal planar surface 16 to be maintained in either a collapsed or extended position. Other configurations which cause the horizontal orientation of the horizontal planar surface 16 to be maintained are possible.

Another embodiment of the present invention is a waterfowl decoy 12 including a decoy body 48 attached to a stabilizing keel 10 as described above. Thus, the scope of the present invention includes both an aftermarket keel kit which a hunter or photographer may add to existing decoys and complete decoy and keel units.

The vertical planar surface 18 of the stabilizing plate 14 and the first and second planar strut surfaces 22, 44 are preferably planar parallel. Thus, these structures together define a relatively broad planar face which is substantially vertically oriented when attached to a waterfowl decoy 12 which is operatively positioned. These structures may be attached to the decoy body 48 parallel to the longitudinal centerline 50 of the decoy body 48 as shown in FIG. 6. In addition, the vertical planar surface 18 and the first and second planar strut surfaces 22, 44 intersect the horizontal planar surface 16 of the stabilizing plate 14 at right angles. Thus, the horizontal planar surface 16 is held substantially horizontally when the stabilizing keel 10 or waterfowl decoy 12 are operatively disposed. Typically, a decoy will be placed on the surface of a pond or other body of water. The horizontal and vertical surfaces described above effectively provide fluid resistance against wind or wave generated torque applied to the decoy body 48. Thus, the planar surfaces of the stabilizing keel 10 resist rocking motion which may be imparted to the decoy body 48.

The orientation of the horizontal planar surface 16 described above is particularly effective at providing fluid resistance to any front or rear torque which would impart a nose-to-tail rocking motion to a decoy body 48. The nose-to-tail type of rocking motion is not effectively resisted by a keel which features only vertically oriented members positioned along the longitudinal centerline of a decoy. Similarly, the combination of the vertical planar surface 18, planar strut surfaces 22, 44, and the horizontal planar surface 16 will provide fluid resistance to side-to-side rocking motions caused by lateral torque applied to the decoy body 48. Thus, the stabilizing keel 10 of the present invention effectively provides fluid resistance to mitigate wind and wave induced rocking motions caused by torque applied along either the longitudinal or lateral axis, or any combination thereof. A waterfowl decoy 12 incorporating the stabilizing keel 10 of the present invention rests more stably on the surface of the water in windy or choppy conditions, and thus better mimics an actual waterfowl.

As described above in detail, the configuration of the elements of the stabilizing keel of the present invention allows the stabilizing plate 14 to be extended away from the decoy body 48. The extended position is readily apparent in FIG. 2 when compared to the collapsed position depicted in FIG. 5. Extension of the stabilizing plate 14 away from the decoy body 48 increases the moment arm between the center of fluid resistance provided by various parts of the stabilizing keel 10 and the decoy body 48. Thus, extension of the stabilizing plate 14 away from the decoy body 48 causes the stabilizing keel 10 to more effectively mitigate wind and wave induced rocking motions.

Hunters or photographers will typically carry several decoys into the field and set them in an arrangement selected to mimic a flock of waterfowl on the surface of a pond. Transportation or storage of numerous relatively bulky decoys can be problematic. The first and second articulated connections 38, 46 between the struts 20, 40 and the stabilizing plate 14 of certain embodiments of the present invention, along with suitably articulated attachment means 24, 42 for each strut 20, 40, allows the stabilizing keel 10 to be collapsed toward the attachment means 24, 42 and decoy body 48 as shown in FIG. 4. This collapsed position may be employed to achieve a more compact waterfowl decoy 12 for transportation and storage.

It is occasionally useful for a hunter or photographer to deploy decoys in a field, meadow, or marsh or along the shoreline surrounding a body of water. The horizontal planar surface 16 of the stabilizing plate 14 effectively provides a stand which will support a land-set decoy 12 in a realistic, upright position. In addition, an embodiment which features a stabilizing plate 14 which may be collapsed toward the decoy body 48 as described above allows a hunter or photographer to selectively set the height the decoy body 48 is held above the surface of the ground. This feature can be useful when placing decoys 12 in relatively tall grass or brush, or when attempting to mimic waterfowl resting on the ground. A wide range of adjustment to the height a land-set decoy body 48 is supported above the ground is facilitated by positioning the attachment means 24, 42 and articulated connections 38, 46 at the corners of a parallelogram. As described above, such a configuration allows the stabilizing plate 14 to maintain its horizontal configuration whether the plate 14 is positioned in a collapsed or extended position.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A stabilizing keel for attachment to a waterfowl decoy comprising:
a stabilizing plate including a horizontal planar surface;
a first strut connected to the stabilizing plate; and
first attachment means operatively associated with the first strut for attaching the first strut to a waterfowl decoy such that the horizontal planar surface is positioned substantially horizontally when the stabilizing keel is operatively oriented.

2. The stabilizing keel of claim 1 wherein the stabilizing plate further comprises a vertical planar surface normal to the horizontal planar surface.

3. The stabilizing keel of claim 2 wherein the first strut comprises a first planar strut surface.

4. The stabilizing keel of claim 3 wherein the first planar strut surface and the vertical planar surface are planar parallel when the stabilizing keel is operatively oriented.

5. The stabilizing keel of claim 1 wherein the connection between the first strut and the stabilizing plate is articulated providing for the selective extension of the stabilizing plate away from the first attachment means and the selective collapsing of the stabilizing plate toward the first attachment means.

6. The stabilizing keel of claim 1 further comprising:
a second strut connected to the stabilizing plate; and
second attachment means operatively associated with the second strut providing for the attachment of the second strut to a waterfowl decoy.

7. The stabilizing keel of claim 6 wherein the first and second struts comprise first and second planar strut surfaces which are co-planar with each other and positioned substantially vertically when the stabilizing keel is operatively oriented.

8. The stabilizing keel of claim 6 wherein the connection between the first strut and the stabilizing plate is a first articulated connection, and the connection between the second strut and the stabilizing plate is a second articulated connection providing for the selective extension of the stabilizing plate away from the first and second attachment means and the selective collapsing of the stabilizing plate toward the first and second attachment means.

9. The stabilizing keel of claim 8 wherein the positions of the first and second articulated connections cause the horizontal orientation of the horizontal planar surface to be maintained in the collapsed and extended positions.

10. A waterfowl decoy comprising:
a decoy body;
a stabilizing plate including a horizontal planar surface; and
a first strut connected to the stabilizing plate and further attached to the decoy body such that the horizontal planar surface is positioned substantially horizontally when the waterfowl decoy is operatively oriented.

11. The waterfowl decoy of claim 10 wherein the stabilizing plate further comprises a vertical planar surface normal to the horizontal planar surface.

12. The waterfowl decoy of claim 11 wherein the vertical planar surface is held parallel to a longitudinal centerline of the decoy body.

13. The waterfowl decoy of claim 11 wherein the first strut comprises a planar strut surface and the planar strut surface and the vertical planar surface are planar parallel when the stabilizing keel is operatively oriented.

14. The waterfowl decoy of claim 10 wherein the connection between the first strut and the stabilizing plate is articulated allowing the selective extension of the stabilizing plate away from the decoy body and the selective collapsing of the stabilizing plate toward the decoy body.

15. The waterfowl decoy of claim 10 further comprising a second strut connected to the stabilizing plate and further attached to the decoy body.

16. The waterfowl decoy of claim 15 wherein the first and second struts comprise first and second planar strut surfaces which are co-planar with each other and positioned substantially vertically when the waterfowl decoy is operatively oriented.

17. The waterfowl decoy of claim 15 wherein the first and second struts are attached to the decoy body parallel to a longitudinal centerline of the decoy body.

18. The waterfowl decoy of claim 15 wherein the connection between the first strut and the stabilizing plate is a first articulated connection, and the connection between the second strut and the stabilizing plate is a second articulated connection providing for the selective extension of the stabilizing plate away from the decoy body and the selective collapsing of the stabilizing plate toward the decoy body.

19. The waterfowl decoy of claim 15 wherein the positions of the first and second articulated connections cause the horizontal orientation of the horizontal planar surface to be maintained in the collapsed and extended positions.

20. A method of deploying a waterfowl decoy on a body of water comprising:
providing a decoy including a decoy body, a horizontal stabilizing plate and a vertical strut attached to both the underside of the decoy body and the horizontal plate;
manipulating the vertical strut to increase the distance between the horizontal stabilizing plate and the decoy body; and
placing the decoy on the surface of the body of water.
